(19) United States
(12) Patent Application Publication
(10) Pub. No.: US 2019/0122134 A1
(43) Pub. Date: Apr. 25, 2019

(54) SYSTEMS AND METHODS FOR UNIVERSAL REVERSIBLE COMPUTING

(71) Applicants: Trustees of Boston University, Boston, MA (US); University of Central Floria Research Foundation,, Orlando, FL (US)

(72) Inventors: Claudio Chamon, Lexington, MA (US); Eduardo Mucciolo, Oviedo, FL (US); Andrei E. Ruckenstein, Brookline, MA (US); Zhicheng Yang, Boston, MA (US)

(21) Appl. No.: 16/092,623

(22) PCT Filed: Apr. 14, 2017
(86) PCT No.: PCT/US17/27652

§ 371 Date: Oct. 10, 2018

Related U.S. Application Data
(60) Provisional application No. 62/323,006, filed on Apr. 15, 2016.

(51) Int. Cl. G06N 10/00; G06N 7/00; G06F 9/38

(52) U.S. Cl. CPC G06N 10/00; G06F 2009/3883; G06F 9/3877; G06N 7/005

(57) ABSTRACT

Methods for performing computations using a lattice of interconnected devices are described. The lattice is programmed to perform the computation by choosing a specific logic function for each device. An energy penalty is attributed to each device when the associated input and output bits do not satisfy a truth table of the logic function of the device. Input data is inserted on the boundaries of the lattice by attributing energy penalties to the input and output bits at the boundaries when the states of those bits do not match the input data. The energy in the lattice is lowered for the lattice to reach a configuration where all gate and boundary constraints are satisfied. The result of the computation is read from the output data encoded in the states of the bits of the devices at the boundaries of the lattice which are not already fixed by the input data.

This patent application claims priority from U.S. Provisional Patent Application No. 62/323,006, filed Apr. 15, 2016, the disclosure of which is incorporated by reference herein in its entirety.

### BACKGROUND OF THE INVENTION

The present disclosure relates to the general area of computational systems and methods, and relates more particularly to the mapping of reversible computational circuits onto vertex lattices, and to methods for reaching the ground state of such a system, which encodes the solution to the computational problem represented by the initial circuit.

This section is intended to provide a background or context. The description may include concepts that may be pursued, but have not necessarily been previously conceived or pursued. Unless indicated otherwise, what is described in this section is not deemed prior art to the description and claims and is not admitted to be prior art by inclusion in this section.

Approaches inspired by statistical physics have been used to solve hard problems in areas of computer science such as neural networks, machine learning, compressed sensing, satisfiability, and data mining, to name a few. One of the most important topics at the interface between physics and computer science is quantum computing, namely, the ability to perform large-scale universal computations by exploring and controlling quantum phenomena such as superposition and entanglement. However, despite recent progress in developing hardware for universal quantum computing, only systems with a very limited number of high-quality quantum bits have been built so far, and they are insufficient for any significant practical use.

The situation is better in regard to non-universal quantum machines where the quality of individual quantum bits is less critical. In this case, machines with over a thousand quantum bits are already commercially available. These machines are naturally designed to solve optimization problems, where by an appropriate preparation of the initial state and a suitable variation of fields, one drives the quantum bits toward a ground state that encodes the solution of the problem. In this process, known as quantum annealing, as fields are swept, one often encounters near-degenerate ground states that can steer the machine away from the desired solution. The only way of keeping the machine in the desired ground state is to sweep fields sufficiently slowly; yet, if the nearly-degenerate states are associated a glass transition, the time of sweep must scale exponentially with the number of quantum bits involved, resulting in an exponentially long time to reach the solution. Often, the same limitation occurs when using thermal annealing, which consists of lowering the temperature of a system of bits (classical or quantum) whose interactions are such that the ground state of the system encodes the solution of a computational problem. If a finite-temperature glass transition appears during the thermal annealing process, the computation is slowed down exponentially. Thus, finding ways of encoding universal computations in an annealing machine that avoids glass transitions is very desirable. More generally, developing statistical mechanics models that represent classical computation without interference from finite-temperature phase transitions is relevant to the identification and exploration of other dynamical pathways for relaxation into ground states (beyond classical and quantum annealing) that optimize time to solution.

### BRIEF SUMMARY OF THE INVENTION

The below summary is merely representative and non-limiting.

The above problems are overcome, and other advantages may be realized, by the use of the embodiments.

In accordance with the present disclosure, systems and methods that provide a platform for utilizing annealing and other computational methods to implement universal reversible computations are provided. The present disclosure is suitable for application to such difficult computational problems as satisfiability, factoring, and other similar tasks. The system and method provide reversible logic circuits in terms of interconnected vertices of a lattice, with each vertex describing a logic gate. Typically, the circuit implements a verification function f(x) of a computational problem in the NP complexity class, although any algorithmically computable function f(x) can be implemented. By adding ancilla bits and choosing appropriate boundary conditions for the lattice, one can run the computation in reverse and, for a given output y, find the input x such that y=f(x). This approach works well when the number of input values x that satisfy y=f(x) for a given y is limited and does not scale with the number of bits required to store x. However, it can be used in any situation.

According to an aspect of the present disclosure, the logic circuit that implements the verification function f(x) is implemented in terms of reversible logic gates that can involve two or more bits, such as TOFFOLI gates. Additional auxiliary gates such as IDENTITY and SWAP gates can be inserted in the circuit to create a regular pattern and to avoid the crossing of bit lines. In the physical implementation, bit lines that represent the evolution of bit states in time are replaced by physical connections between bits. Thus, a lattice of gates in two-dimensional space emerges, with gates enforcing logic relations among input and output bits and interconnects enforcing the same logic state between output bits of a gate and input bits of a neighboring gate. All gates are physically implemented by suitable two-body interactions among input and output bits which give an energy penalty to bit configurations that do not satisfy the gate's truth table. The resulting system is that of physical bits coupled by local one- and two-body interactions. The physical bits can be either classical or quantum.

According to another aspect of the present disclosure, the bits on the input and output boundaries of the circuit can be left unconstrained or be constrained by the application of a strong local field. The choice of which bits to constrain or not establishes the direction of computation: forward, backward, or mixed.

According to an aspect of the present disclosure, starting from an appropriate initial state for all bits, the system is annealed toward its ground state, where it reaches a configuration where all bits at the boundaries satisfy the function implemented by the circuit.

The presently disclosed embodiments show how to prepare the Chimera lattice configuration of the D-Wave System machine into a form appropriate to implement any reversible logic circuit and corresponding vertex gate lattice for universal computation through annealing.

The presently disclosed systems and methods may be applied to evaluate any multivariable Boolean expression for circuit satisfiability, or factoring sub-prime numbers.

### BRIEF DESCRIPTION OF THE SEVERAL VIEWS OF THE DRAWINGS

The present disclosure is described in greater detail below, with reference to the accompanying drawings, in which:

FIG. 1 is a block diagram that illustrates the layout of a reversible circuit that implements a one-bit ripple adder;

FIG. 2 is a block diagram that illustrates a physical implementation of reversible gates in terms of devices connecting input and output quantum or classical bit systems in accordance with an embodiment;

FIG. 3 is a block diagram that illustrates the two-qubit interactions used to implement energy cost functions that enforce the truth table of a given logic gate;

FIG. 4 is a block diagram that illustrates a physical implementation of a one-bit ripple adder;

FIG. 5 is an illustration of the construction of a vertex model;

FIG. 6 is a block diagram that illustrates the procedure for embedding a 4×4 gate lattice into the Chimera architecture; and

FIG. 7 is a logic flow diagram that illustrates the operation of a method, and a result of execution of computer program instructions embodied on a computer readable memory, in accordance with various embodiments.

### DETAILED DESCRIPTION OF THE INVENTION

In accordance with the present disclosure, a Boolean function over N variables is expressed in terms of reversible TOFFOLI, SWAP, and IDENTITY, as well as other gates. Three-bit TOFFOLI gates implement logic operations among binary variables, while two-bit SWAP gates are used to reduce the operation of any logic gate to adjacent variables. Two-bit IDENTITY gates fill gaps such that the combination of TOFFOLI, SWAP, and IDENTITY gates over the N parallel bit lines representing the evolution of the Boolean variables creates a lattice.

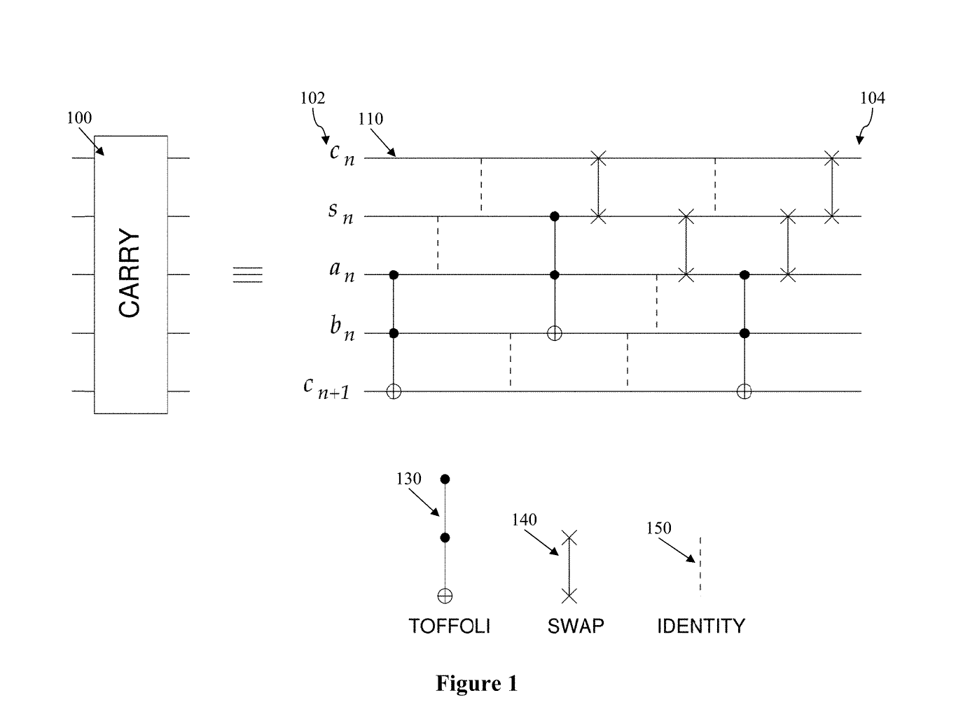

FIG. 1 shows an example of such a lattice for a one-bit ripple-adder circuit 100 where N=5. As shown, three types of reversible gates are used: TOFFOLI 130, SWAP 140, and IDENTITY 150. The gates are represented by vertical lines that join points located on adjacent bit lines 110. In this example, the left end 102 of the bit lines 110 represent the input value of the N variables, while the right end 104 represents the outcome value of the same Boolean function.

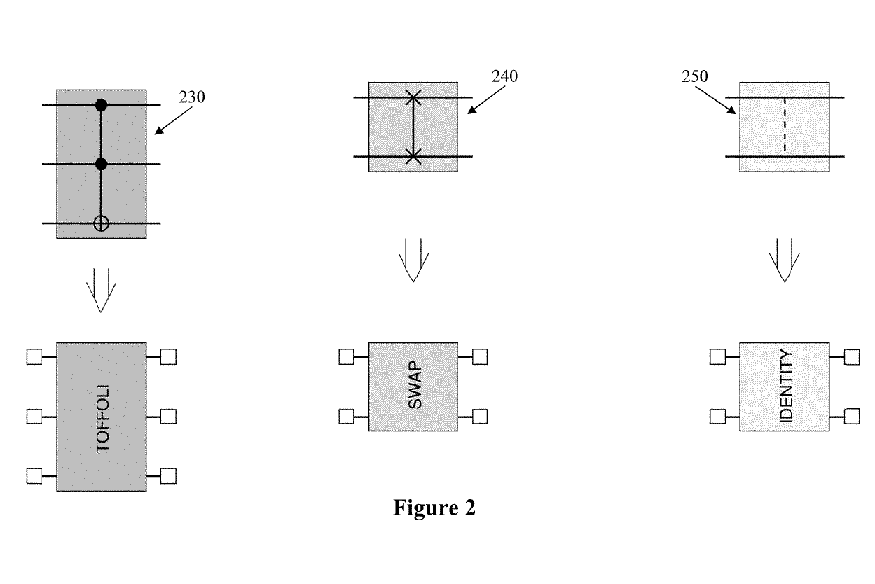

While in an ordinary representation of a circuit the bit lines indicate the direction of time, in this disclosure they indicate a real space dimension. In the physical implementation of the invention, quantum or classical bits systems (hereafter referred as qubits) are placed at the input and output lines going in and out of the gate, respectively. Thus, the gates are planar devices that connect input and output qubits, as illustrated in FIG. 2. SWAP and IDENTITY gates 240, 250 connect four qubits, while TOFFOLI 230 connects six qubits. The logic function associated to each gate is enforced by suitable two-bit interactions between pairs of input and output qubits. For the TOFFOLI gate 230, an additional internal qubit is used. The sum of these interactions creates a cost function: any input and output states of the qubits which do not satisfy the truth table associated to the gate are penalized with an energy cost; states that do satisfy the truth table are penalty free.

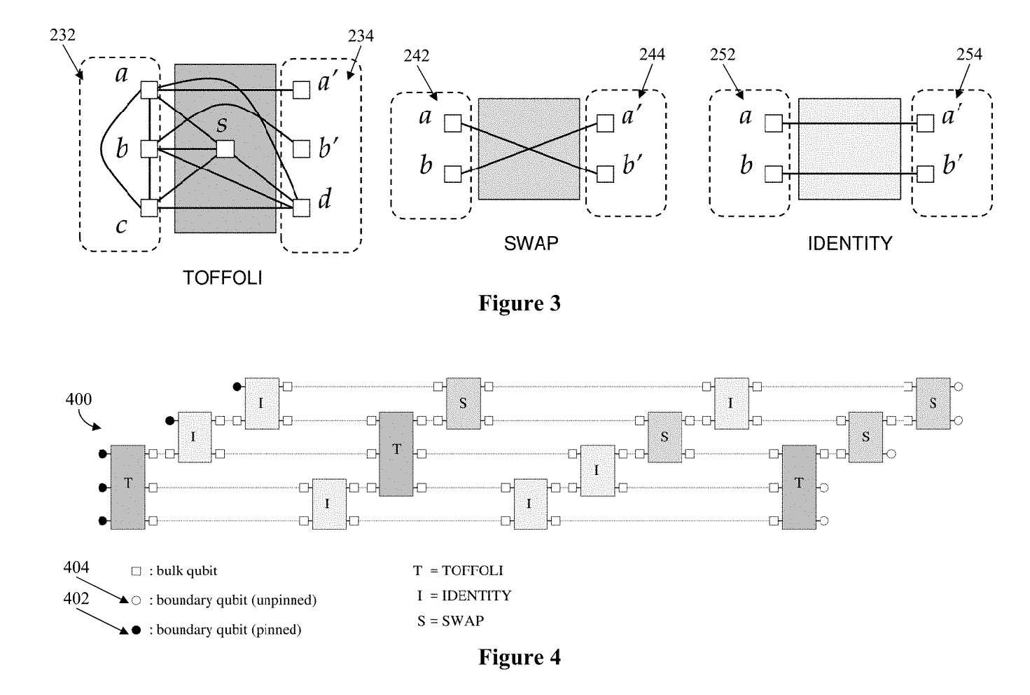

FIG. 3 shows schematically the two-bit interactions used to implement the energy cost function for each type of reversible gate. Below we layout expressions for each one of these energy cost functions. The positive constant J controls the strength of the interactions. For classical bits, a binary variable σ=±1 is associated to each qubit of the gate. For quantum bits, one makes the substitution σ=σ^{z}, where σ^{z} is a Pauli operator.
TOFFOLI gate:

E_{TOFFOLI}(σₐ, σ_{b}, σ_{c}; σ_{a′}, σ_{b′}, σ_{d}; σ_{S})=−J(σₐσ_{a′}+σ_{b}σ_{b′})+J(σₐ−3σ_{b}−2σ_{c}+2σ_{d}+4σ_{S})+J(−3σₐσ_{b}−2σₐσ_{c}+4σ_{b}σ_{c}+2σₐσ_{d}−4σ_{b}σ_{d}−4σ_{c}σ_{d}+4σₐσ_{S}−8σ_{b}σ_{S}−6σ_{c}σ_{S}+6σ_{d}σ_{S})

where a, b, c denote the three input qubits 232 (a and b are control bits and c is the target bit) and a′, b′, d denote the three output bits 234; a seventh auxiliary qubit denoted by s is also employed in order to satisfy the truth table with just one- and two-bit interactions.
SWAP gate:

E_{SWAP}(σₐ, σ_{b}; σ_{c}, σ_{d})=J(σₐσ_{d}+σ_{b}σ_{c})

where a, b denote the two input qubits 242 and c, d denote the two output qubits 244.
IDENTITY gate:

E hd IDENTITY (σₐ, σ_{b}; σ_{c}, σ_{d})=J(σₐσ_{c}+σ_{b}σ_{d})

where a, b denote the two input qubits 252 and c, d denote the two output qubits 254.

The collection of gates that implement the circuit Boolean function form a lattice. Input and output qubits belonging to adjacent gates are connected by a ferromagnetic two-bit interaction. Here, (a) denotes an output qubit of a gate on the left and (b) denote an input qubit of a gate on the right. The energy cost associated to the connection between these two qubits is the following:

E_{connect}(σₐ, σ_{b})=−Kσₐσ_{b}

where K is a positive constant that controls the strength of the interaction. FIG. 4 illustrates the connecting interactions between qubits of adjacent gates.

For the purpose of pinning qubits located on the left (input) and right (output) boundaries of the circuit, local fields are employed. The total energy cost function implemented by the boundary fields is expressed as:

E_{boundary}({σₖ})=−Σ_{k∈boundary}hₖσₖ

where {hₖ} are fields acting on individual qubits. By setting hₖ»K, the variable σₖ is set to the value+1, while for −hₖ»K, the same variable is set to the value −1.

FIG. 4 shows the qubits and interactions required to implement a one-bit ripple adder function. Pinned qubits 402, logic gates T, I, S, and connections are implemented through the energy cost functions given above. The pinned qubits 402 unpinned qubits 404

Once the physical implementation of the circuit is established, the computation problem to be solved can be encoded in the following way. Let x represent the state of the n input qubits on the left-hand side of the circuit, x=(x₁, . . . , xₙ), and y represent the state of the n output qubits on the right-hand side of the circuit, y=(y₁, . . . , yₙ). Three cases arise:
1) Forward computation: given x, find y such that y=f(x). In this case, the n qubits in x are pinned and the n qubits in y are left unpinned.
2) Backward computation: given y, find x such that y=f(x). In this case, the n qubits in y are pinned and the n qubits in x are left unpinned.
3) Mixed computation: given a subset A of m_{A} qubits in y and a subset B of m_{B} qubits in x, find the remaining n−m_{A} qubits in y and the remaining n−m_{B} qubits in x such that y=f(x). In this case, the combined m_{A}+m_{B} qubits in is subsets A and B are pinned and the remaining n−m_{A}−m_{B} qubits in the same sets are left unpinned.

Solution to the Computational Problem By Annealing

The solution to the computational problem is encoded in the ground state of the system described above. Thermal and quantum annealing, or a combination of both approaches, are possible means to bring the system to its ground state.
Thermal annealing: the ground state of the system can be reached by gradually lowering the temperature of the system, until it reached the minimal energy state. In the system described, because there is no thermodynamic phase transition encountered as the temperature is lowered and the lattice is finite, the temperature can be lowered to the scale T=K/ln(W), where W is the width of the lattice.
Quantum annealing: the ground state of the system can be reached by gradually changing a parameter in the system's Hamiltonian, working at the lowest possible temperature attainable in a given realization of the system.
Combination of thermal and quantum annealing: the ground state of the system can be reached by gradually changing a parameter in the system's Hamiltonian,

while at the same time lowering the temperature of the system.

Vertex model: Combining all the energy cost functions listed above leads us to a total energy cost function E_{C} for the lattice of gates that includes the interactions internal to each gate, the coupling between the qubits at the boundary between adjacent gates, and the fields associated with the input and output bits defining the boundary conditions of the computation:

$${E}_{C} = {\sum }_{ℊ} {E}_{ℊ} ( {\{ σ \}}_{ℊ} ) - K {\sum }_{〈 i , j 〉} {σ}_{i} {σ}_{j} - {\sum }_{k ∈ boundary} {h}_{k} {σ}_{k}$$

where {σ}_{g} represents all the qubits belonging to gate g and E_{g} is the energy cost function of the same gate. A transverse uniform field Γ can be added for the purpose of implementing quantum annealing, in which case the total energy cost function can be expressed as a Hamiltonian:

$${H}_{C} = {\sum }_{ℊ} {E}_{ℊ} ( \{ {\hat{σ}}_{ℊ}^{z} \} ) - K {\sum }_{〈 i , j 〉} {\hat{σ}}_{i}^{z} {\hat{σ}}_{j}^{z} - {\sum }_{k ∈ boundary} {h}_{k} {\hat{σ}}_{k}^{z} + Γ {\sum }_{i} {\hat{σ}}_{i}^{x}$$

where \hat{σ}ᵢ^{z} and \hat{σ}ᵢ^{x} are non-commuting Pauli operators.

For the purpose of using a numerical method to reach the ground state of the lattice system, one can build a model where all gate constraints and input boundary constrains are satisfied, amounting to making the coupling constant J infinite in comparison to the coupling constant K. To represent the qubit state configurations that satisfy all gate truth tables we introduce the set of variables {q_{g}}, with one variable for each gate g of the lattice, where q_{g} ranges from 0 to r_{g}−1. Here, r_{g} is the number of allowable qubit states that are compatible with the truth table of gate g. For two-bit reversible gates involving four qubits, r_{g}=4, namely, out of the 16 possible input and output qubit configurations, only four are allowed. For three-bit reversible gates involving six qubits, where the total number of input and output configuration is 256, only eight are allowed and r_{g}=8. In terms of the new variables {q_{g}}, the total Hamiltonian is written as:

$${H}_{C}^{vertex} = - {\sum }_{〈 ℊ , {ℊ}^{′} 〉} {\sum }_{{q}_{ℊ} = 0}^{{r}_{ℊ} - 1} {\sum }_{{q}_{{ℊ}^{′}} = 0}^{{r}_{{ℊ}^{′}} - 1} {K}_{{q}_{ℊ} {q}_{{ℊ}^{′}}}^{ℊ {ℊ}^{′}} \vert {q}_{ℊ} {q}_{{ℊ}^{′}} 〉 〈 {q}_{ℊ} {q}_{{ℊ}^{′}} \vert - {\sum }_{ℊ ∈ boundary} {\sum }_{{q}_{ℊ}} {h}_{{q}_{ℊ}} \vert {q}_{ℊ} 〉 〈 {q}_{ℊ} \vert + {\sum }_{ℊ} {\sum }_{{q}_{ℊ} {q}_{{ℊ}^{′}}} {Δ}_{{q}_{ℊ} {q}_{{ℊ}^{′}}} \vert {q}_{ℊ} 〉 〈 {q}_{{ℊ}^{′}} \vert$$

The coefficients K_{q}_{_{g}}_{q}_{_{g′}}^{g g′} encode the energy cost of associated to gates g and g′ with mismatched states q_{g} and q_{g′}. The brackets [symbol] g, g′ [symbol] denote nearest-neighbor gates. The coefficients Δ_{q}_{_{g}}_{q}_{_{g′}} quantify the effect of the uniform transverse field on the gate states in leading order in the limit of Γ«J.

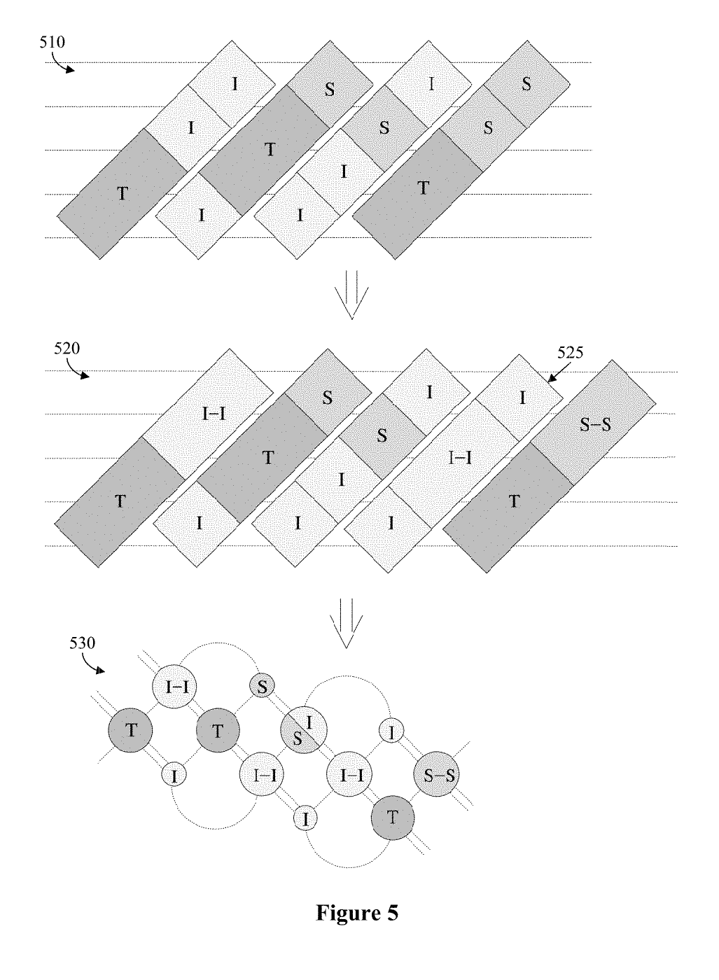

The system comprised by the variables {q_{g}} and the total Hamiltonian expressed above defines a vertex model. The vertices are located at the gates and are connected by two types of links: single-qubit and double-qubit, depending on how many common qubits two neighboring gates shared. The vertex model can be defined on a regular square lattice 500 according to the following procedure illustrated in FIG. 5:
(i) in 510, the boxes used to represent gate devices in FIG. 4 are slanted and sized to cover the region limited by the input and output boundary qubits; TOFFOLI gates are represented by rectangular boxes with aspect ratio 1:2 and SWAP and IDENTITY gates are represented by square boxes;
(ii) optionally, empty spaces may be filed with square boxes indicating the location of auxiliary IDENTITY gates, for example, IDENTITY gates 525 may be added in various embodiments;
(iii) in 520, neighboring square boxes disposed along the same slanted direction are merged into a single rectangular box, resulting in four possible combinations, namely IDENTITY-IDENTITY, IDENTITY-SWAP, SWAP-IDENTITY, SWAP-SWAP;
(iv) in 530, each box is turned into a vertex represented by a circle; and
(v) links are draw to connect circles according to the number of two-qubit interactions shared by the gates represented by the circles.

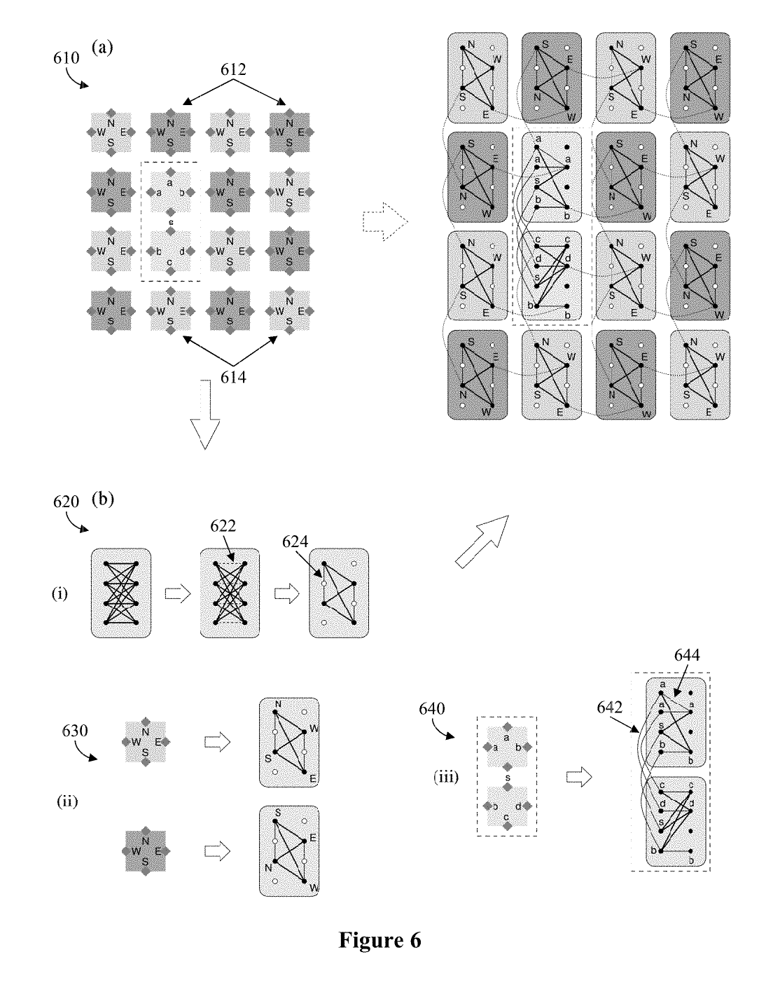

Seven vertices are possible in this construction: in addition to the five rectangles mentioned above, there are vertices corresponding to a single SWAP gate and to a single IDENTITY gate.
Application: factoring subprime numbers. One example of a problem that can be programed in the described system is that of finding the prime factors of a semi-prime number. This particular problem is an example of a mixed boundary condition computation. The first step is to setup one of many possible reversible integer multiplication circuits. One possible reversible circuit for multiplying two N-bit numbers p and q can be constructed using no more than 5N+1 bits in each column. One uses two N-bit registers for the two numbers p and q to be multiplied, one N-bit carry register c for the ripple-sums, a 2N-bit register s for storing the answer p×q=s, and one ancilla bit b. For multiplication, one fixes the boundary conditions on the input: p and q are the two numbers to be multiplied, and c, s and b are all 0's. For factorization we impose mixed boundary conditions: On the input side the c, s and b registers are fixed to be all 0's; on the output side the s register is now fixed to the number to be factorized, and c and b are again all set to 0. Thus, 3N+1 bits in the input and output are fixed, while 2N bits are floating on both boundaries.
Chimera encoding: The vertex model can be encoded in a quantum annealer. In particular, it is possible to implement an explicit embedding of a lattice of reversible gates capable of universal classical computing circuits into the Chimera architecture of a D-Wave Systems machine. A single unit cell of the Chimera is used to implement IDENTITY gates, as well as SWAP gates. TOFFOLI gates require two unit cells to be embedded in the Chimera architecture. The is interactions E_{TOFFOLI}, E_{SWAP}, and E_{IDENTITY} are enforced by using the programmable couplers available in the D-Wave Systems machine, as illustrated in FIG. 6.

FIG. 6 shows the flow chart of embedding a 4×4 gate lattice into the Chimera graph.

(a) Left: a generic tile lattice 610 rotated by 45°. Qubits are put on the boundary of each gate. The lattice can be further divided into two sublattices, depicted by dark 612 and light grey 614 respectively; right: embedding of the tile lattice into the Chimera architecture. The couplings between qubits belonging to neighboring gates are indicated by dotted links. (b) Embedding of each gate into the unit cells of the Chimera architecture. (i) Left: a K_{4,4} unit cell 620 of the Chimera architecture; middle: in order to couple qubits in the same column, we slave the qubits to their neighbors in the other column using additional ferromagnetic couplings indicated by dotted links 622; right: effectively we are left with four qubits that are fully connected. For simplicity, we hereafter denote the effective couplings between spins in the same column by a single thin link 624. However, one should keep in mind that they are obtained by slaving the spins to the opposite column via large ferromagnetic couplings. (ii) The four qubits 630 in the rotated square tile are labeled by their locations on the tile: N (North), S (South), W (West) and E (East). Tiles corresponding to different sublattices may be embedded differently due to the special connectivity of the Chimera graph. (iii) Embedding of the TOFFOLI gate 640 consisting of two square tiles into two unit cells. (a, b, c, d) corresponds to the input and output bits of the gate, and s is the ancilla bit. In the unit cell, ferromagnetic couplings that copy spins are indicated by thin links 642, and couplings required in E_{TOFFOLI} are indicated by thick links 644.

The entire lattice is rotated by 45° for convenience, and qubits living on the boundary of each gate are shown explicitly. The lattice of gates can be further divided into two sublattices labeled by dark and light grey.

Now let us first consider how to encode the IDENTITY and SWAP gates represented into a unit cell. The embedding involves internal couplings J that enforce the gate constraints, and the inter-qubit couplings K that match adjacent gates. The Chimera is unit cell forms a complete bipartite graph K_{4,4} as depicted in FIG. 6b-(i), with each qubit in one column coupled to all qubits in the other, but not to those in their own column. In order to obtain the generic qubit couplings to represent the gates, which inevitably involves couplings between qubits in the same column as well, an additional ferromagnetic coupling slaves the qubits in one column to their nearest neighbors in the other column, resulting in four qubits that are fully connected. Details are shown in FIG. 6b-(i).

In order to use the connectivity of the Chimera architecture and couple adjacent gates properly, one explores the bipartiteness of the square lattice. Let us take one gate from the rotated gate lattice, and label the four qubits by their locations on the gate: N (North), S (South), W (West) and E (East), as shown in FIG. 6b-(ii). The qubits in the adjacent gates are matched by the coupling K. An inspection of the resulting lattice, shows that qubits labeled by N and W in one gate are connected respectively to qubits S and E in neighboring gates. Therefore, once the embedding of a unit cell in one sublattice is fixed, the embedding of the other sublattice must be different, because qubits in one unit cell are coupled to those at the same place in the neighboring unit cell. The map of the two sublattices of the gate lattice in the unit cells as illustrated in FIG. 6b-(ii).

To embed the TOFFOLI gate uses two unit cells of the Chimea, and the qubits coupled between these two cells exactly provide the ancilla bit needed in E_{TOFFOLI}. Similar to the IDENTITY and SWAP gates considered above, within a unit cell and additional ferromagnetic coupling is used to slave qubits from one column to the other when necessary. The explicit mapping is shown in FIG. 6b-(iii). In order to come up with a proper embedding, one has to take into account how qubits are coupled to adjacent unit cells.

Adopting these procedures, one arrives at the embedding of the entire 4×4 gate lattice into the Chimera architecture, as shown in FIG. 6a.

As described above, various embodiments provide a method, apparatus and computer program(s) to solve a computation using a two-dimensional lattice of interconnected devices with input, output and internal bits, which can be classical or quantum.

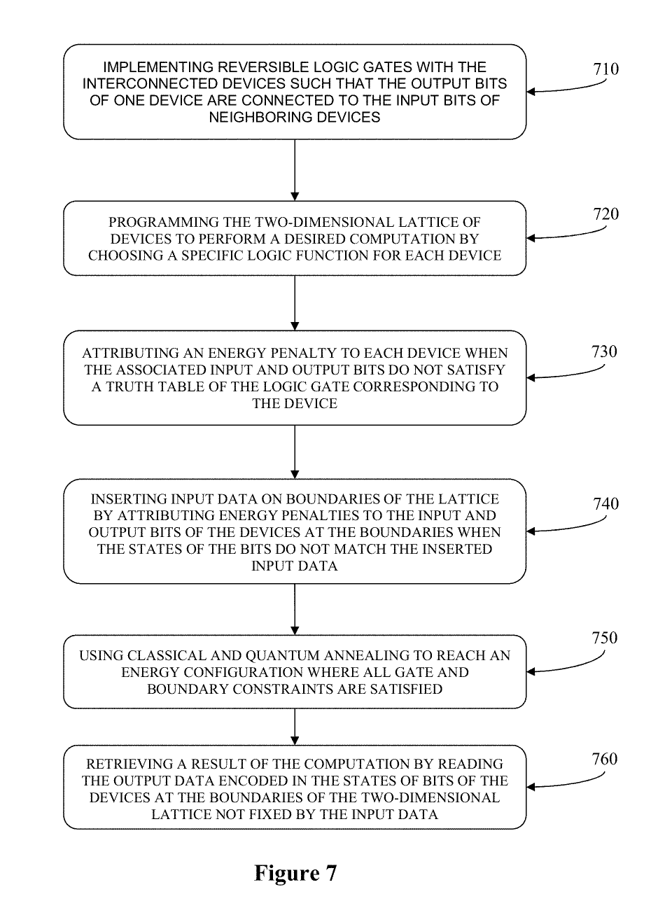

FIG. 7 is a logic flow diagram that illustrates a method, and a result of execution of computer program instructions, in accordance with various embodiments. In accordance with an embodiment a method performs, at Block 710, a step of implementing reversible logic gates with the interconnected devices such that the output bits of one device are connected to the input bits of neighboring devices. The method performs a step of programming the two-dimensional lattice of devices to perform a desired computation by choosing a specific logic function for each device at Block 720. At Block 730 attributing an energy penalty to each device when the associated input and output bits do not satisfy the truth table of the logic gate corresponding to the device is performed by the method. Input data is inserted on boundaries of the lattice by attributing energy penalties to the input and output bits of the devices at the boundaries when states of the bits do not match the inserted input data at Block 740. At Block 750 the method performs a step of using classical and quantum annealing to reach an energy configuration where all gate and boundary constraints are satisfied (note that in other, non-limiting embodiments other techniques to reach the state of the lattice with the lowest energy may be used) and, at Block 760, a step of retrieving a result of the computation by reading the output data encoded in the states of bits of the devices at the boundaries of the two-dimensional lattice not fixed by the input data.

The various blocks shown in FIG. 7 may be viewed as method steps, as operations that result from use of computer program code, and/or as one or more logic circuit elements constructed to carry out the associated function(s).

Various operations described are purely exemplary and imply no particular order. Further, the operations can be used in any sequence when appropriate and can be partially used. With the above embodiments in mind, it should be understood that additional embodiments can employ various computer-implemented operations involving data transferred or stored in computer systems. These operations are those requiring physical manipulation of physical quantities. Usually, though not necessarily, these quantities take the form of electrical, magnetic, or optical signals capable of being stored, transferred, combined, compared, and otherwise manipulated.

Any of the operations described that form part of the presently disclosed embodiments may be useful machine operations. Various embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines employing one or more processors coupled to one or more computer readable medium, described below, can be used with computer programs written in accordance with the teachings herein, or it may be more convenient to construct a more specialized apparatus to perform the required operations.

The procedures, processes, and/or modules described herein may be implemented in hardware, software, embodied as a computer-readable medium having program instructions, firmware, or a combination thereof. For example, the functions described herein may be performed by a processor executing program instructions out of a memory or other storage device.

The foregoing description has been directed to particular embodiments. However, other variations and modifications may be made to the described embodiments, with the attainment of some or all of their advantages. Modifications to the above-described systems and methods may be made without departing from the concepts disclosed herein. Accordingly, the invention should not be viewed as limited by the disclosed embodiments. Furthermore, various features of the described embodiments may be used without the corresponding use of other features. Thus, this description should be read as merely illustrative of various principles, and not in limitation of the invention.

What is claimed is:

1. A method for computing using a lattice of interconnected devices, each device having input, output and internal bits, which can be classical or quantum bits, comprising:
implementing reversible logic gates with the interconnected devices such that the output bits of one device are connected to the input bits of neighboring devices;
programming the lattice of devices to perform a desired computation by choosing a specific logic function for each device;
attributing a gate energy penalty to each device when the associated input and output bits do not satisfy a truth table of the logic gate corresponding to the device;
inserting input data on boundaries of the lattice by attributing boundary energy penalties to the input and output bits of the devices at boundaries of the lattice when states of the bits do not match the inserted input data;
lowering energy in the lattice to reach an energy configuration where all gate and boundary constraints are satisfied; and
retrieving a result of the computation by reading the output data encoded in the states of bits of the devices at the boundaries of the lattice not fixed by the input data.

2. The method of claim 1, wherein attributing a gate energy penalty to each device comprises coupling the input, output, and internal bits of the given device with one- and two-bit interactions.

3. The method of claim 2, wherein the couplings between the input, output, and internal bits of a given device are chosen to implement an individual TOFFOLI, SWAP, and IDENTITY gate, or a combination of TOFFOLI, SWAP, and IDENTITY gates.

4. The method of claim 1, wherein an input bit of a first device and an output bit of a second are coupled by a two-bit interaction.

5. The method of claim 1, wherein attributing a boundary energy penalty comprises implementing a one-bit interaction.

6. The method of claim 1, wherein the inserted input data to the lattice of devices is encoded entirely on the boundaries of the lattice.

7. The method of claim 1, wherein the inserted input data to the lattice of devices is encoded partially on the boundaries of the lattice.

8. The method of claim 1, wherein lowering the energy in the lattice comprises using at least one of: classical and quantum annealing.

9. The method of claim 1, wherein lowering the energy in the lattice to reach the energy configuration where all gate and boundary constraints are satisfied comprises performing quantum annealing by applying transverse fields to input, output, and internal bits of all devices.

10. The method of claim 1, wherein the devices are arranged in a three-dimensional lattice.

11. A method for programming a quantum annealer with a Chimera architecture to emulate a lattice of devices that implements reversible logic gates, comprising:
interconnecting qubits of the quantum annealer with interactions that enforce logic functions within at least one Chimera cell to implement the reversible logic gates; and
interconnecting inputs and outputs of distinct reversible logic gates by interactions coupling qubits belonging to distinct Chimera cells to form a lattice of devices that implements reversible logic gates.

12. The method of claim 11, wherein two-bit reversible logic gates are implemented in one Chimera cell, further comprising:
selecting four qubits in the Chimera cell to serve as two input bits and two output bits of the gate;
selecting the remaining qubits in the Chimera cell to serve as internal auxiliary bits; and
selecting one-bit and two-bit interactions within the Chimera cell to penalize bit configurations where the input and output bits do not satisfy the truth table of the reversible logic gate.

13. The method of claim 11, wherein three-bit reversible logic gates are implemented in two Chimera cells, further comprising:
selecting three qubits of a first Chimera cell to serve as two input bits and one output bit of the gate, and three qubits of a second Chimera cell to serve as one input bit and two output bits of the reversible logic gate;
selecting the remaining qubits in the two Chimera cells to serve as internal auxiliary bits; and
selecting one-bit and two-bit interactions within the two Chimera cells and between the two Chimera cells to penalize bit configurations where the input and output bits do not satisfy the truth table of the reversible logic gate.

14. A method for representing computational problems as a vertex lattice, comprising:
representing reversible logic gates as vertices in a square lattice, where inputs and outputs to each vertex are constrained to satisfy the truth table of the logic gate;
coupling neighboring vertices through single or double links, which contain one or two bits, such that the output bits of one vertex are coupled via a ferromagnetic interaction to the input bits of neighboring vertices, and such that an energy penalty is assigned when the output bits of one vertex are different from the input bits in the neighboring vertex;
selecting the specific reversible logic gate represented at each vertex such that the vertex lattice performs a desired computation;
inserting input data on boundaries of the vertex lattice by attributing energy penalties to input and output bits of vertices at the boundaries of the vertex lattice when input or output bit states do not match the inserted input data; and
using a numerical method to reach a lowest energy configuration where all the interconnections and boundary constraints are satisfied.

15. The method of claim 14, wherein the truth tables couplings of inputs, outputs, and internal states to the vertices are chosen to implement TOFFOLI gates, SWAP gates, IDENTITY gates, or a combination of TOFFOLI, SWAP and IDENTITY gates.

16. The method of claim 14, wherein the numerical method to reach the lowest energy configuration is a simulation of thermal annealing in a digital computer.

17. The method of claim 14, wherein the numerical method to reach the lowest energy configuration is a simulation of quantum annealing in a digital computer.
